(19) United States
(12) Patent Application Publication
(10) Pub. No.: US 2007/0006556 A1
(43) Pub. Date: Jan. 11, 2007

(54) Particle filter including a metallic fiber layer

(75) Inventors: Rolf Bruck, Bergisch-Gladbach (DE); Peter Hirth, Rosrath (DE); Thomas Harig, Neunkirchen-Seelscheid (DE)

Correspondence Address: LERNER GREENBERG STEMER LLP, P O BOX 2480, HOLLYWOOD, FL, 33022-2480, US

(73) Assignee: Emitec Gesellschaft fur Emissionstechnologie mbH

(21) Appl. No.: 11/483,702

(22) Filed: Jul. 10, 2006

Related U.S. Application Data
(63) Continuation of application No. PCT/EP04/14650, filed on Dec. 23, 2004.

(30) Foreign Application Priority Data
Jan. 9, 2004 (DE) 10 2004 001 417.5

(51) Int. Cl. B01D 46/00

(52) U.S. Cl. 55/282.2

(57) ABSTRACT

A particle filter includes a casing and at least one body disposed in the casing and having at least one metallic fiber layer. The at least one metallic fiber layer forms a multiplicity of spatially separate flow paths through the body. The flow paths each have a flow restrictor at least at one location. The at least one metallic fiber layer has an area-related thermal capacity in a range of from 400-1200 Joule per Kelvin and square meter [J/Km²]. The particle filter therefore has an especially high particle storage capacity and regeneration capacity.

### CROSS-REFERENCE TO RELATED APPLICATIONS

This is a continuing application, under 35 U.S.C. §120, of copending International Application No. PCT/EP2004/014650, filed Dec. 23, 2004, which designated the United States; this application also claims the priority, under 35 U.S.C. §119, of German Patent Application DE 10 2004 001 417.5, filed Jan. 9, 2004; the prior applications are herewith incorporated by reference in their entirety.

### BACKGROUND OF THE INVENTION

### Field Of The Invention

The present invention relates to a particle filter including a casing and a body, wherein the body is formed with at least one metallic fiber layer. The fiber layer is disposed in the body in such a way that flow paths are formed through the body. The flow paths each have a flow restrictor at least at one location.

A differentiation is basically made between “open” and “closed” systems, in the case of particle filters which are used, for example, in exhaust systems of mobile internal combustion engines (spark ignition engines, diesel engines, etc.). “Open” systems generally have flow paths which can be flowed through freely, with calming zones and/or swirl zones being made available which cause particles to be moved toward the walls that bound the flow paths. At the same time, that is intended to increase the probability of the particles located in the exhaust gas coming into contact with the other parties to the reaction which are made available through the use of the walls of the flow paths or the exhaust gas itself, so that the particles are converted into harmless components. Examples of such open systems are disclosed in German Utility Model DE 201 17 873 U1, corresponding to U.S. Patent Application Publication No. US2004/0013580 A1 or International Publication No. WO 03/038248 A1, corresponding to U.S. Patent Application Publication No. US2004/0187456 A1.

Particle filters according to the “closed” system generally have flow paths which are closed off alternately so that partial flows of exhaust gas pass through a wall of the flow paths at least once. For that purpose, it is known to position sealing elements or flow restrictors at the inlet or the outlet of the flow paths and in addition it is also known to provide such elements in the interior of the flow paths. The walls of the flow paths are formed, for example, from a porous material which is predominantly of a ceramic nature.

“Closed” systems in which the filter material constitutes a metallic fiber layer are also known. Such a configuration is disclosed, for example, in European Patent EP 0 764 455 B1, corresponding to U.S. Pat. No. 5,800,790. In the filter described in that document, which has the purpose of precipitating soot particles from exhaust gases, a metallic fiber layer is mounted in a housing in such a way that the stream of exhaust gas penetrates the latter only once. In addition to planar or wave-shaped configurations in which the flow through the metallic fiber layer is substantially axial, cylindrical or star-shaped configurations of the fiber layer in which the gas flow is fed centrally and directed radially outward through the metallic fiber layer through the use of a closure cap lying opposite are also described.

In particular, when particle filters according to the “closed” system are made available, there is a risk of the porous walls or the walls composed of the fiber layer becoming blocked with particles (always to be understood as a generic term for a large number of solids in the exhaust gas of the automobile, in particular also soot and ash) if the parties in the reaction which are necessary for chemical conversion cannot be made available to a sufficient degree. That results in the walls of the flow paths forming an increasing resistance. As a result thereof, for example, the ram or back pressure rises and at the same time the power of the internal combustion engine is reduced. For that reason, it is generally necessary to free the particle filters from particles which are situated in them, which is usually referred to by the term “regeneration”.

A large number of thermal processes are known for carrying out regeneration, in which an increase in temperature is selectively brought about in the exhaust gas or in the particle filter, these being, for example, temperatures above 800 degrees Celsius at which the particles are burnt or oxidized. Such thermal regeneration can be initiated by particular heating elements which are part of the particle filter itself or are connected thereto. However, it is also possible to initiate a type of post-combustion through the use of induced, possibly catalytic, reactions in the exhaust gas flow. For example, ammonia or else a quantity of fuel are added as additives. In addition to such discontinuous thermal regeneration of the particle filter, continuous methods are also known.

Such a continuous method is often referred to as the so-called CRT (Continuous Regeneration Trap) system. In that context, the exhaust gas is firstly fed through an oxidation catalytic converter and then into a soot filter. The oxidation catalytic converter has the function of converting nitrogen monoxides (NO) which are contained in the exhaust gas into nitrogen dioxide (NO₂). An increased proportion of nitrogen dioxide has the advantage that redox reactions occur in the particle filter connected downstream, with carbon (C) being oxidized into carbon dioxide (CO₂), and the nitrogen dioxide (NO₂) being reduced to form pure nitrogen (N₂). As a result, in particular carbon monoxide (CO) and long-chain hydrocarbons (HC) which are often contained in the particles are already almost completely converted in a temperature range between 200 degrees Celsius and 450 degrees Celsius.

However, in these CRT systems it is to be noted that only a virtually sulfur-free diesel fuel (less than 10 ppm S) should be used in order to avoid putting the redox system described above at risk. In order to supplement the nitrogen monoxides contained in the exhaust gas or the nitrogen dioxide formed therefrom, further addition of ammonia upstream of the oxidation catalytic converter can provide further advantages.

The effectiveness or filtering effect of the particle filter is also described by the surface or the pores etc. with which the filter wall is provided. In this context it is always an objective to make available the largest possible surface for filtering the particles. At the same time, the particle filter should withstand the high thermal and dynamic loads in the exhaust gas system of the mobile internal combustion engine. In that context, in particular the different thermal expansion behaviors of the component of the particle filter are to be taken into account. In addition, it should be possible to regenerate the particle filter in order to ensure long-lasting use.

### SUMMARY OF THE INVENTION

It is accordingly an object of the invention to provide a particle filter including a metallic fiber layer, which overcomes the hereinafore-mentioned disadvantages of the heretofore-known devices of this general type and which fulfills the objectives mentioned above. Furthermore, the filter is to make available the largest possible filtering surface and withstand relatively frequent regeneration. Furthermore, the specified particle filter is also to be capable of withstanding possibly brief, locally limited and significantly increased peaks in temperature in the interior of the particle filter, thus ensuring a long service life particularly with respect to repeated regeneration.

With the foregoing and other objects in view there is provided, in accordance with the invention, a particle filter. The particle filter comprises a casing and at least one body disposed in the casing. The at least one body has at least one metallic fiber layer having an area-related thermal capacity in a range of from 400-1200 Joule per Kelvin and square meter [J/Km²]. The at least one metallic fiber layer forms a multiplicity of spatially separate flow paths through the body and the flow paths each have a flow restrictor at least at one location.

The metallic fiber layer is preferably manufactured in this case from a heat-resistant, corrosion-resistant material, and in particular includes fibers on an iron basis or steel basis which include proportions of aluminum and chromium. In particular, fibers made of a material which is based on iron with proportions of aluminum and chromium as well as, if appropriate, proportions of rare earths such as, for example, yttrium, are used as materials for the metallic fiber layer. The aluminum content is preferably at least 4.5 percent [%] and in particular above 5.5%. The chromium content is preferably in a range of from 18% to 21%.

The fibers can be aligned in this case to form a fabric, nonwoven or tangle or in some other way. The connection between the fibers itself is also constructed in a heat-resistant or corrosion-resistant fashion, in particular the fibers are sintered to one another.

In order to form a body, the at least one metallic fiber layer is preferably stapled, wound, wrapped or disposed in some other way. In this context it is possible to form bodies with just one metallic fiber layer, but it is also possible for a plurality of metallic fiber layers which are possibly constructed differently from one another to be connected to form a coherent fiber strip and/or for a multiplicity of such fiber layers to be provided.

The at least one metallic fiber layer at least partially bounds flow paths in this case, that is to say constitutes at least one wall or one wall section of the flow path. The flow paths are preferably disposed substantially parallel to one another and separated from one another in particular over their entire length. In this context, separated is not necessarily intended to mean that it is not possible for gas to be exchanged between adjacent flow paths, but rather a honeycomb-like configuration of the flow paths is meant.

Each of these flow paths preferably has a flow restrictor at precisely one location. Basically, it is proposed to select the inlet cross section or the outlet cross section of the flow path as the location. Alternatively, or in combination therewith, it may also be expedient to provide a flow restrictor in the interior of the flow path, that is to say between the inlet cross section and the outlet cross section. The flow restrictor is preferably configured in such a way that it provides a relatively large resistance with respect to the flowing through of a stream of fluid compared to the fiber layer (forming the filter layer) as a boundary between the flow paths. This also means that the flow restrictor is constructed with a larger, volume-specific density than the metallic fiber layer, in particular also in a way which is impermeable to gas.

With such an embodiment of the body formed from at least one metallic fiber layer with which a multiplicity of cells is made available, the regeneration of the particle filter could, under certain circumstances, constitute a problem. The seal-forming manner in which the partial regions of the fiber layer lie with respect to one another and the quantity of soot which is possibly stored therein leads to a situation in which locally limited extreme temperature peaks can arise when the soot is converted during the regeneration process. This can cause the structure of the fiber layer to be destroyed, in particular components of the fiber layer melt and/or the connections between the fibers are destroyed. In order to prevent components of the fiber layer from becoming detached due to these so-called hot spots, and thus other partial regions of the particle filter possibly becoming blocked or components of the exhaust gas treatment system which are disposed downstream of the particle filter being destroyed, it is proposed in this case according to the invention that the at least one metallic fiber layer have an area-related or superficial thermal capacity in the range from approximately 400 to 1200 J/Km². In this context, the data on the area-related thermal capacity are related to room temperature. The at least one metallic layer preferably has an area-related thermal capacity of more than 750 J/Km² or even more than 1000 J/Km². It has become apparent that particularly in such particle filters which have a multiplicity of cells or flow paths, the provision of the aforesaid area-related thermal capacity is prevented and that the metallic fiber layer (for example also in the interior partial regions of the particle filter which are difficult to cool) permanently withstands the alternating thermal stresses, as well as the so-called hot spots, which occur in the exhaust system of a mobile internal combustion engine.

In accordance with another feature of the invention, the fiber layer has at least one of the following parameters in at least one section:
a) fiber diameter: 20 μm to 90 μm;
b) fiber spacing: 5 μm to 300 μm;
c) layer thickness: 0.2 mm to 1.5 mm;
d) layer weight per unit surface area: 250 g/m² to 2000 g/m²;
e) layer porosity: 30% to 90%;
f) fiber surface per 1 m² layer surface: 9 m² to 15 m²; and
g) length of individual fiber: 5 μm to 100 μm.

With respect to the at least one “section” it is to be noted that it preferably includes the entire length, width or spatial extent of the fiber layer, but it is also possible for the latter to describe, for example, just a partial region in the axial direction and/or radial direction of the fiber layer. Under certain circumstances it is also expedient for the fiber layer to include a plurality of such sections, in which case the section does not have to be formed in the same way each time but rather the dimensioning can be adapted in a variable fashion to the conditions, for example in the exhaust gas system of an internal combustion engine.

“Fiber diameter” means the average diameter of a fiber of the fiber layer. The average value does not result in this case from an averaging of all of the diameters of an individual fiber but rather preferably the diameter of the fiber represents a characteristic value for all of the fibers of the fiber layer in the at least one section. The fiber diameter preferably lies in a range of from 40 μm to 70 μm (0.04-0.07 mm).

“Fiber spacing” means in particular the distance between adjacent fibers of the fiber layer, in which case the largest distance from one another is predominantly meant in this case. The fiber spacing constitutes, in particular, a parameter for representing the permeability to gas or the density of the fiber layer. This fiber spacing preferably lies in a range of from 20 μm to 300 μm (0.02-0.3 mm).

“Layer thickness” means the thickness of the at least one metallic fiber layer, in particular in the direction of the throughflow of the exhaust gas. The layer thickness is preferably 0.3 mm to 0.5 mm.

The “layer weight per unit surface area” which describes the weight of the metallic fiber layer per unit surface area lies preferably in a range of from 750 to 1500 grams per square meter [g/m²].

The layer porosity is preferably between 45% and 60%.

The “fiber surface” constitutes in this sense the surface which is formed by the individual fibers together. In contrast to this, “layer surface” means the surface (envelope) of the metallic fiber layer itself.

“Individual fiber length” is understood to be the length of the fiber which is used predominantly to manufacture the at least one metallic fiber layer. The individual fiber length is preferably 10 μm to 30 μm (0.01-0.03 mm).

In accordance with a further feature of the invention, a refinement of the particle filter is also proposed in which the at least one fiber layer is disposed in the body in such a way that at least one of the following parameters is present:
a) the specific layer surface is: 0.15 m²/l to 2.0 m²/l; and/or
b) the layer distance is: 0.5 mm to 10 mm.

A “specific layer surface” is to be understood as the layer surface which is located in a volume of the particle filter of one liter [l]. This provides a characteristic variable which is suitable as a measure for the given filter volume. If smooth and corrugated metallic fiber layers are used to construct the particle filter, different regions can be preferred. Thus, a specific layer surface between 0.15 m²/l and 1.0 m²/l is preferred, for example, if only the smooth layer is composed of a metallic fiber layer. If only the corrugated layers are constructed with a metallic fiber layer, the specific layer surface lies in a range of from 0.25 m²/l to 1.0 m²/l. If both corrugated layers and smooth layers are constructed with a metallic fiber layer, the specific layer surface is advantageously between 0.4 m²/l and 2.0 m²/l. Especially with regard to use in diesel engines, in particular a particle filter which has a specific layer surface of 0.5 m²/l to 0.9 m²/l is proposed.

“Layer distance” means the distance between sections or fiber layers which are disposed adjacent one another. The layer distance in this case describes the distance which is present in the region of the largest distance between adjacent fiber layers. This value of the layer distance is to be measured in particular between layer surfaces through which the gas flow flows in or out. This value can also vary over the axial length of the particle filter or over the length of the flow paths.

In accordance with an added feature of the invention, the body includes at least one supporting structure which spaces apart from one another fiber layer regions that are disposed at least partially adjacent one another. The supporting structure thus fulfills, at least over a partial region, the function of preventing fiber layer regions which are disposed adjacent one another from resting directly one on top of the other. In particular, this supporting structure serves to form cells or flow paths. The supporting structure can be disposed between separate fiber layers and between folds, turns or the like of an individual fiber layer. The supporting structure is preferably formed from metal and extends over the entire length of the flow cells which are formed. In turn, the material for the supporting structure preferably includes iron/aluminum/chromium, as was described above with respect to the fibers.

In accordance with an additional feature of the invention, the at least one supporting structure includes at least one of the following components, individually or multiply: lattice or grid, sheet metal, wire, expanded metal. Lattice or grid is understood to mean various configurations of wire fabrics, wire meshes, tangled layers etc. These are preferably configured in a gas-permeable fashion with openings, passages etc. It is also possible for further filter material to be placed in these openings, cutouts, etc. The last-mentioned variant relates in particular to the refinement of the supporting structure as expanded metal. It is also possible in particular for structured pieces of sheet metal, etc. to be positioned between the filter layers or fiber layers. The pieces of sheet metal preferably are impenetrable to a gas flow but can if necessary also include openings or flow baffle surfaces. It is also possible in particular for shaped wires to be disposed between the fiber layer regions which are in particular structured or else smooth. Such wires are to be preferably positioned in the inlet region or in the outlet region of the flow paths. It is also possible for a plurality of such wires to be disposed to form a wire bundle and to be positioned between the fiber layer regions.

In accordance with yet another feature of the invention, the components of the body are connected through the use of a technical joining connection, to one another at least in certain regions, and/or to the casing. Components of the body mean in particular the fiber layers and the supporting structures. The technical joining connections are preferably disposed in this case in the following regions: end faces of the particle filter (on which the exhaust gas impacts or from which the exhaust gas leaves), near the structural maximum points of supporting structures, in the contact region of the fiber layer and supporting structure, or between two fiber layers. In this context, the technical joining connection is preferably configured as a diffusion connection, welded connection and/or brazed connection. With respect to the connection of the components to the casing, it is preferred for all the ends of the fiber layers and/or the supporting structures to form in each case a technical joining connection in the above sense.

In accordance with yet a further feature of the invention, the at least one flow restrictor is part of the at least one supporting structure, wherein the at least one flow restrictor closes off at least one flow path at least at one location. This means that the supporting structure preferably has a fold around it, forms wings, a collar etc. and thus fits snuggly against or is adapted to at least one adjacent metallic fiber layer. The flow restrictor is for this purpose preferably constructed substantially in a gas-tight fashion so that a gas flow cannot penetrate it (at least under conditions such as occur in exhaust gas systems of automobiles). In this context, the supporting structure is preferably constructed as a piece of sheet metal which engages around an edge of the adjacent metallic fiber layer.

In accordance with yet an added feature of the invention, the at least one flow restrictor has a shape which is adapted to the course, or fits snugly at least partially against the profile, of the at least one fiber layer, in which case it closes off some of the flow paths at least near an inflow side or an outflow side of the body. In this case, the flow restrictor is constructed as a separate component and is disposed in such a way that it closes off at least some of the flow paths. In the embodiment of the particle filter which is described herein, it is assumed that the fiber layers are disposed in a layered, wrapped or wound fashion. This means that their end faces describe a helical, linear, S-shaped or similar profile or course. Since the fiber layers at least partially bound flow paths which flow closely over their surface, the flow paths which are located near an individual fiber layer are closed off with an individual flow restrictor. For this purpose, the flow restrictor substantially follows the profile of the at least one fiber layer. Since particle filters according to the “closed” system are preferably described in this case, the cells or flow paths which are closed off on alternate sides are brought about by virtue of the fact that in each case a first number of flow restrictors on the inflow side close off a certain number of flow paths, while a second number of flow restrictors on the outflow side close off the remaining flow paths. Preferably, a wire or a cord-like, substantially gas-tight, configuration is used as a flow restrictor.

In accordance with yet an additional feature of the invention, the at least one flow restrictor includes a device for regenerating the particle filter and/or is suitable for determining at least one of the following parameters: temperature and/or components of the gas flow. In the embodiment of the particle filter described herein, the flow restrictor has both the function of sealing off flow paths and an additional function, specifically, for example, the initiation of the regeneration of the particle filter or the determination of measurement values. With respect to the regeneration of the particle filter, the flow restrictor can be constructed, for example, as a heating wire, in which case a current can flow through it and the heat required for the thermal regeneration can be conducted away in the particle filter on the basis of resistance heating. It is also possible for the flow restrictor itself to be formed as a sensor or the like. In this case, the latter serves, for example, as a temperature measuring sensor or else as a sensor for detecting gas components of the exhaust gas flow (for example oxygen, nitrogen oxides, hydrocarbons, etc.).

In accordance with again another feature of the invention, the body has an overall volume which lies in the range of from 0.5 to 3.0 liters [1] per 1.0 liter [1] cubic piston capacity or displacement of the corresponding internal combustion engine. Overall volume is meant in this context to refer to the volume of the body including the metallic fiber layers, the supporting structures, the flow restrictors, etc. and the space which the flow paths enclose. The overall volume of the body is preferably generally bounded by the inflow side and the outflow side of the body and by the inner surface of the casing. The preferred range of the overall volume is 1.0 to 1.5 l/1.5 per liter cubic piston capacity. The cubic piston capacity or displacement is the overall combustion space available in the internal combustion engine, and it is customarily also used to refer to the size of the internal combustion engine.

In accordance with again a further feature of the invention, the body is constructed as a honeycomb body having a multiplicity of cells or passages or channels, and a cell density per cross-sectional area through the body is provided which is in a range of from 100 cpsi to 400 cpsi. At this point it is firstly to be noted once more by way of clarification that the cells are bounded both by the surfaces of the at least one fiber layer and, if appropriate, by the surface of the at least one supporting structure. The cell density is given in “cpsi”, which stands for “cells per square inch”.

In accordance with again an added feature of the invention, the body has a multiplicity of fiber layers which are connected to one another alternately at the opposite inflow side and outflow side in order to form flow restrictors and pockets. In each case a supporting structure with a minimum height and a maximum height is provided between the fiber layers, the latter being disposed in an alternating orientation in adjacent pockets. This means in other words that the supporting structures form flow paths which widen between the fiber layers, in which case a flow path in which a supporting structure with the maximum height is located is disposed adjacent a flow path in which the supporting structure with a minimum height is located. The flow restrictors are preferably positioned near a region of the body in which the supporting structure has its minimum height, and the adjacent fiber layers therefore lie as closely to one another as possible. The provision of such supporting structures leads to a formation of V-shaped pockets if an imaginary cross section through the particle filters is considered, with the opening of the V pointing alternately to the inflow side or outflow side. Such a configuration for particle filters is particularly preferred with respect to the ram or head pressure which is generated in this case and to a simple technical joining connection of fibers layers and supporting structure. In addition it is to be noted that not only individual supporting structures but also groups including a (variable) multiplicity of supporting structures which are oriented in the same way can be disposed alternately.

In accordance with again an additional feature of the invention, the body has segments, in the direction of an axis, with different or combined functions. These segments constitute partial regions of the particle filter through which an exhaust gas flow can flow in succession. The intention is in each case to bring about a different effect on the components contained in the exhaust gas. Examples of such functions are filtering of ash, filtering of soot, oxidation, heating, storage of exhaust gas components, dewatering of gas flows, etc. The metallic fiber layers and the supporting structures and/or flow restrictors can be matched to the function in these segments, in particular using parameters which differ from those in other segments.

It is also possible, for example, for a segment in which mixing of partial gas flows located in the flow paths is to be preferably brought about to be provided in such a particle filter. For this purpose, if appropriate, additional flow restrictors and/or openings can be provided in the walls of the flow paths in order to bring about mixing of partial gas flows.

In accordance with still another feature of the invention, it is advantageous for the body to include at least one internal boundary which is defined by flow restrictors that are aligned with one another. Correspondingly, for example, it is advantageous that in each case contact with the entire exhaust gas flow is to be ensured in different segments in different embodiments of the metallic fiber layer. For this purpose, it is possible to provide for such a segment to be bounded by flow restrictors at the end lying downstream, which restrictors bring about a flow through the fiber layer in this segment. The flow restrictors are preferably parts of the supporting structure and/or parts of the metallic fiber layer itself in this case. Particularly if the flow restrictors form a boundary of the segments mentioned above, it is advantageous for them to be disposed substantially in one plane.

In accordance with still a further feature of the invention, the body is connected to the casing through the use of at least one collar which surrounds it. In the case of particle filters which are constructed from different components (in terms of material, material thicknesses, etc.), the thermal expansion behavior always plays an important role with respect to the durability in exhaust gas systems of internal combustion engines. In addition, the particle filter is subjected to extreme thermal shock loading during the regeneration process. In this case, on one hand the supporting structures which are preferably constructed with relatively thin walls are present, as are also the metallic fiber layers which are somewhat thicker but at the same time less dense, and the solid casing which is constructed, for example, with a thickness of 1 mm or more. All of these components form a different thermal capacity which brings about different expansion behavior particularly when the particle filter is heated or cooled. Since a technical joining connection of the components is nevertheless to be ensured in this case, this can lead to considerable thermal stresses at the joint, which possibly leads to the destruction of the components or of the connection between the components.

In order to avoid this, a collar is proposed which is disposed around the body and is connected on one side to the body and on the other side to the casing (in a very narrow, belt-shaped region). This collar is preferably disposed centrally and extends over only a small region of the outer surface of the body. This means that the body is not permanently connected to the casing over a large part of its circumferential face, and can therefore expand or contract independently thereof. As a result, the largest possible axial and radial freedom of expansion is ensured for the body. The collar additionally has a structured configuration in the circumferential direction in order to permit different expansion in the circumferential direction as well in this way. Examples of such collars are disclosed in particular in International Publication No. WO 03/008774 A1, corresponding to U.S. Patent Application Publication No. US2004/0152594 A1, and its disclosure is incorporated herein and can be used to supplement what is stated herein. In the present case, the collar or the particle filter is advantageously additionally constructed with a seal in order to prevent exhaust gas from flowing past the body. This seal may be part of the collar itself, but it is also possible to place it at other locations, preferably between the body and the casing.

In accordance with still an added feature of the invention, the body is provided at least partially with a coating. The coating can be of a different nature with respect to the function and can be mounted on the fibers, the supporting structure and/or further components of the particle filter. In this context, for example, a platinum oxide coating is preferred, in which 40 to 120 grams per liter [g/l] of washcoat (zeolite) is provided and a noble metal charge is 20 to 100 grams per cubic foot [g/Ft³]. The particle filter has a nitrogen oxide adsorption coating at least in a partial region as a further preferred coating, in which 150 to 300 g/l of washcoat is provided and is constructed with a noble metal charge of 20 to 100 g/Ft³.

In accordance with still an additional feature of the invention, the flow restrictor is disposed near an inflow side and an outflow side of the body and in each case supporting structures are provided between a plurality of fiber layers. At least one of the fiber layers has a connecting section in order to form a technical joining connection to the at least one flow restrictor and/or a supporting structure. This means in particular that the metallic fiber layer is configured in such a way that a brazed connection to adjacent components is possible. For example, a filler material for the cavities in the fiber layer and a particular compression of the fibers in the metallic fiber layer itself are suitable for this purpose. Compression of this connecting section can be brought about, for example, by folding over the fiber layer in partial regions and compressing it.

In accordance with a concomitant feature of the invention, the connecting section is a section of the fiber layer with parameters which are different from the other regions, or a joined-on individual component. This means that, for example, one of the parameters mentioned at the outset herein (fiber diameter, average fiber spacing, layer thickness, layer weight per unit surface area, layer porosity, individual fiber length etc.) is modified in such a way that in this case the fiber material is made so as to be able to be brazed. It is, for example, also possible for this connecting region to be formed by additionally joined-on, in particular able to be brazed, individual components such as, for example, sections of sheet metal or the like.

Other features which are considered as characteristic for the invention are set forth in the appended claims, noting that the features specified in the claims can be combined with one another and with further explanations given in the entire disclosure and can lead to further advantageous refinements of the invention.

Although the invention is illustrated and described herein as constructed in a particle filter including a metallic fiber layer, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of an embodiment of a particle filter according to the invention;

FIG. 2 is an enlarged, fragmentary, perspective view of fiber layers and supporting structures;

FIG. 3 is a fragmentary, perspective, sectional view of a location where flow paths are between the supporting structure and the fiber layer;

FIG. 4 is a further enlarged view of a region IV of the metallic fiber layer shown in FIG. 3;

FIG. 5 is a half-sectional view of a further embodiment of the particle filter according to the invention;

FIG. 6 is a fragmentary, perspective view of a configuration of a metallic fiber layer and supporting structure in an embodiment of a flow restrictor; and

FIG. 7 is a partly broken-away diagrammatic view of an exhaust gas system of a mobile internal combustion engine.

### DESCRIPTION OF THE PREFERRED EMBODIMENTS

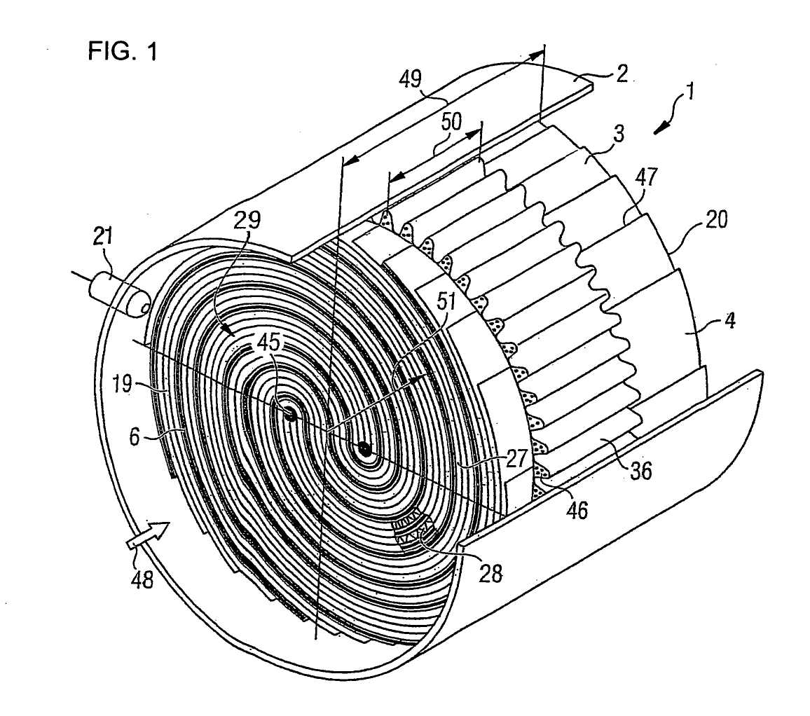

Referring now in detail to the figures of the drawings which show particularly preferred embodiments to which, however, the invention is not restricted and first, particularly, to FIG. 1 thereof, there is seen a diagrammatic and perspective illustration of a first embodiment of a particle filter 1 including a casing 2 and a body 3. The body 3 is formed with a multiplicity of metallic fiber layers 4 which are wound in this case in an S shape about two winding points 45. The body 3 is formed as a honeycomb body 27 and has a multiplicity of cells, channels or passages 28. The cells 28 extend from an inflow side 19 substantially parallel as far as an outflow side 20 of the body 3. In this case, a flow direction 48 is designated by an arrow. A plurality of flow restrictors, preventers or inhibiters 6, which are illustrated in the region of the inflow side 19, substantially follow the S-shaped profile of the configuration of the metallic fiber layers 4. The flow restrictors 6 close off half of the cells 28 on the inflow side 19, while another part of the cells 28 is also closed off by flow restrictors 6 on the outflow side 20 in a non-illustrated manner.

The casing 2, which is constructed in this case as a cylindrical tube, protrudes beyond the body 3 on both sides 19, 20. An additive generator 21, which is provided near the inflow side 19, is constructed as a spray nozzle, for example for ammonia or hydrocarbon-containing fuel.

A technical joining connection of the honeycomb body 27 to the housing or casing 2 is made through the use of a collar 36 which is provided on the periphery of the body 3. The collar 36 is constructed as a corrugated strip and has a smaller width 50 than a length 49 of the honeycomb body 27. The collar 36 is connected at one side to all sheet metal ends 47 of the honeycomb body 27 and on the opposite side to the casing 2. In this way, a compensation possibility for different thermal expansion behavior is provided in particular in radial direction 51.

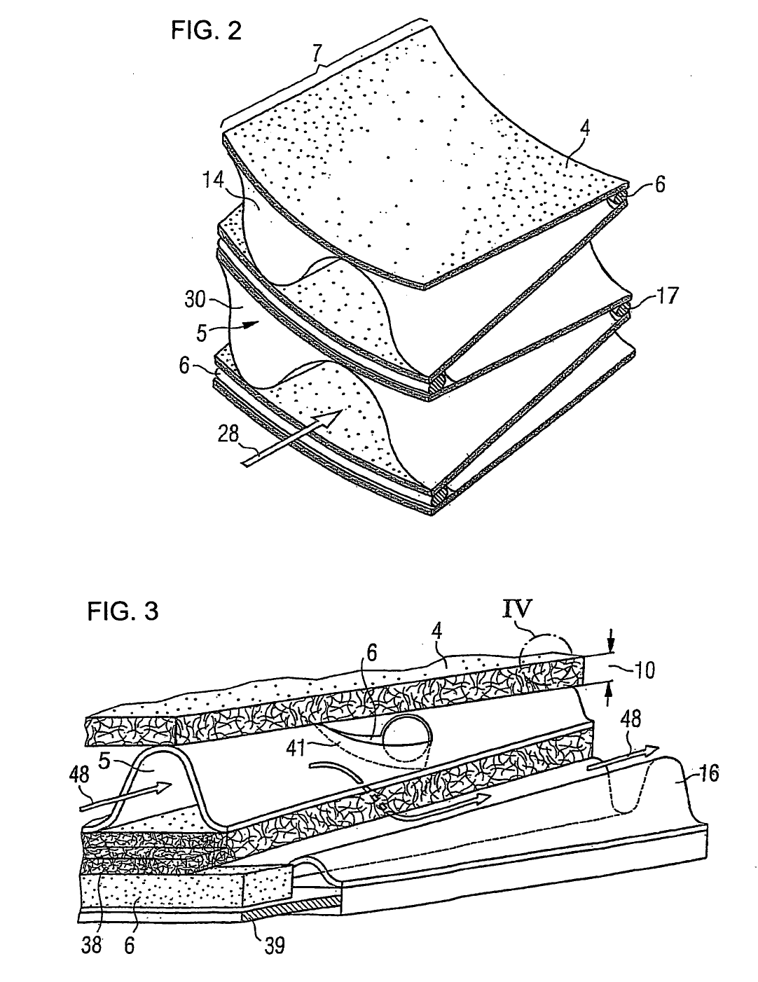

FIG. 2 shows a configuration of an embodiment of the particle filter with pockets 30 which are formed by supporting structures 14 between metallic fiber layers 4. In each case a metallic fiber layer 4 and a supporting structure 14 are disposed alternately in this case, in the radial direction 51. In this context, a section 7 of the fiber layer 4 and the supporting structure 14, which is constructed as a piece of corrugated sheet metal, together bound the flow paths 5. The supporting structure 14 has a relatively large corrugated structure on one end side, while it has a very small amplitude on the opposite end side. A flow restrictor 6, which closes off the flow paths 5, is again provided near the small amplitude of the corrugation of the supporting structure 14. The supporting structures 14 are disposed in alternation with one another so that in this case, as seen in the sectional view, every second metallic fiber layer 4 extends substantially parallel to one another. However, this does not have to be the case, particularly if the supporting structures 14 in adjacent pockets 13 are not configured in the same way. The exhaust gas flow is guided, for example, through the flow path 5 or the cell 28 into internal regions of the particle filter and forced by the flow restrictor 6, or a wire 17 which is constructed as a flow restrictor, to penetrate the metallic fiber layer 4 at least once in order to emerge on the opposite end side.

FIG. 3 shows a further fragmentary view of a stack of metallic fiber layers 4 and supporting structures which are constructed in this case as a piece of sheet metal 16. The illustrated fiber layers 4 have a layer thickness in the region of less than 1 mm. The corrugated sheet metal layer 16, which is disposed between the fiber layers 4, in turn forms flow paths 5 which permit the exhaust gas to flow in along the flow direction 48. A flow restrictor 6, which is formed in the flow path 5, causes the partial gas flow that has entered into the flow path 5 to be deflected through the fiber layer 4 which is disposed adjacently. This partial gas flow is directed into an adjacent cell or flow path 5 and in this way can emerge again from the particle filter in the flow direction 48. The flow restrictor 6 is formed as a protuberance or baffle face 41 of the piece of sheet metal 16. The fiber layers 4 have a connecting section 38 in order to close off some of the cells. Two types of connecting sections are shown one above the other. The connecting section 38 illustrated above is constructed as a compressed fiber layer 4, while an individual component 39 (for example a piece of sheet-metal foil) is illustrated below. In turn, a flow restrictor 6, which is a separate component in this case, for example a sealing cord, is formed between the adjacent connecting section 38 and individual component 39.

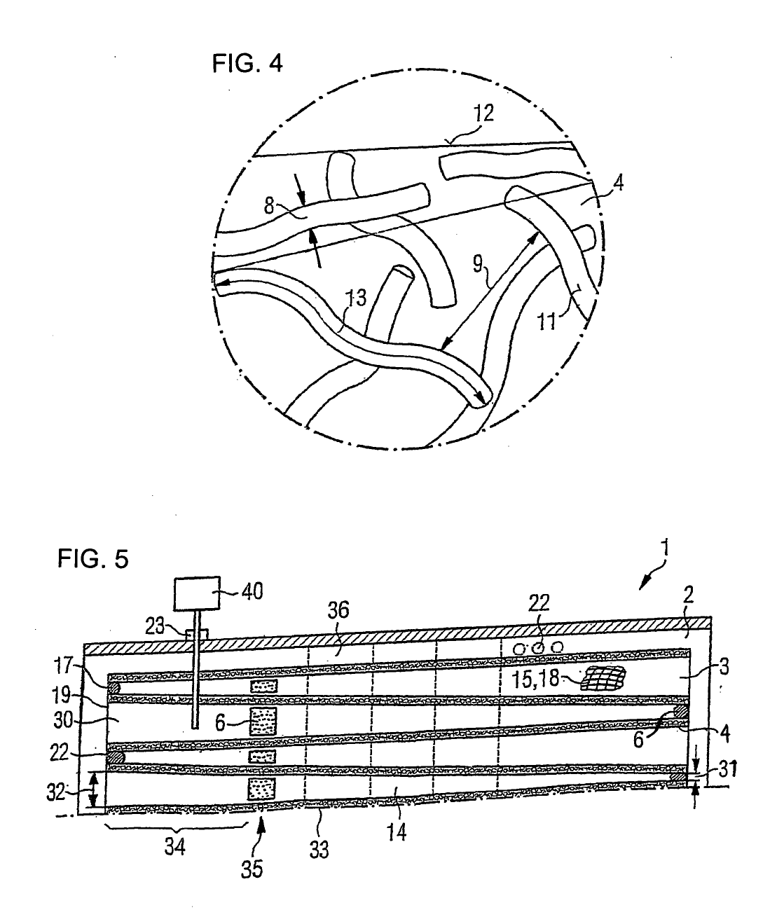

FIG. 4 is a fragmentary view of a partial region of the metallic fiber layer 4, as indicated by reference numeral IV in FIG. 3. A pair of the parameters mentioned above can be discerned therefrom in order to describe the fiber layer 4, in particular a fiber diameter 8, a fiber spacing 9, a fiber surface 11, a layer surface 12 and an individual fiber length 13. The space between the fibers can be filled with air and/or partially with additional materials. These additional materials include coatings, for example.

FIG. 5 shows a further embodiment of the particle filter 1 according to the invention, in a half section. In this case the body 3 has a multiplicity of metallic fiber layers 4 which are closed off alternately on the opposite inflow side 19 and outflow side 20 through the use of the flow restrictor 6 or a heating wire 22 and a sealing wire 17. In this case, not only is the sealing wire 17 constructed for generating a thermal regeneration like the heating wire 22, but in addition further heating wires 22 for initiating a regeneration are located between the casing 2 and the body 3 on the periphery of the body 3. The fiber layers 4 and the flow restrictors 6 together form flow paths which are constructed substantially as pockets 30. In each case supporting structures 14 which have a minimum height 31 and a maximum height 32, and are disposed in an alternating fashion in adjacent pockets 30, are provided in these pockets 30. The supporting structures are configured in this case as a grill or grid 15 or a piece of expanded metal 18.

The body 3 has a segment 34 which is mounted upstream, as seen in the direction of an axis 33, and which is provided, for example, with a coating 37 that has an oxidizing effect. In order to ensure that the onflowing exhaust gas flow penetrates the coated fiber layers 4 at least once, the body 3 has an internal boundary 35 which is formed by flow restrictors 6 that are constructed in the supporting structure 14.

In addition, the particle filter 1 is constructed with a measuring sensor 23 which monitors the functionality of the particle filter 1. The information which is acquired with the measuring sensor 23 can be transferred to an evaluation unit 40 which can trigger a regeneration, for example.

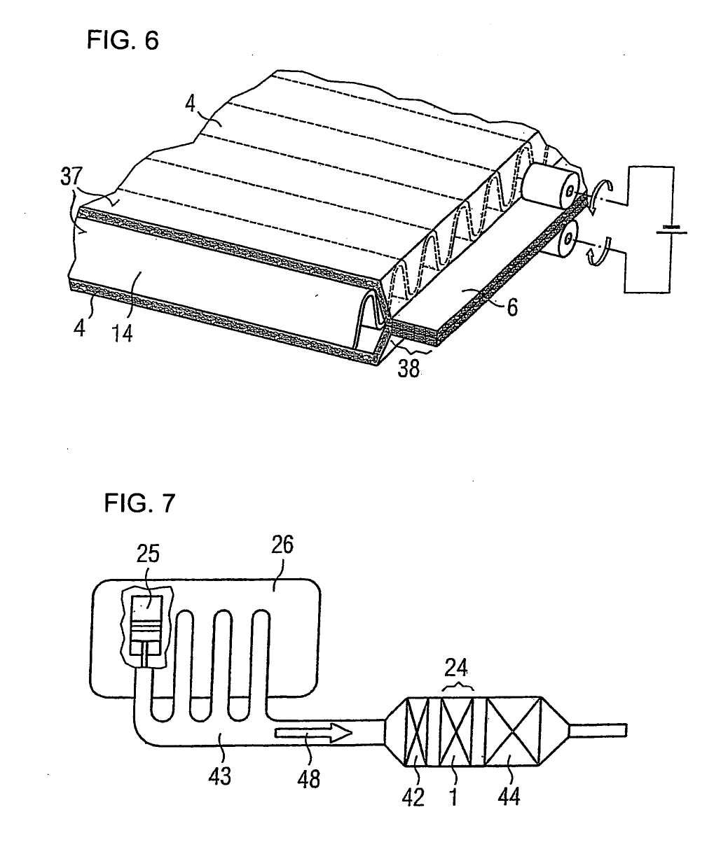

FIG. 6 is a fragmentary view of an embodiment of a flow restrictor 6 placed near an inflow side or an outflow side of the particle filter 1. In order to provide for such a placement, the metallic fiber layers 4 are made longer than the supporting structure 14 so that they project beyond the supporting structure 14 and touch one another. The fiber layers 4 in this connecting section 38 are configured in such a way that they ensure a technical joining connection with one another. In this case, it is roughly illustrated that the two fiber layers 4 which are disposed adjacent one another are connected to one another through the use of a roll seam welding method and thus form a flow restrictor 6.

FIG. 7 is a diagrammatic view of the structure of an exhaust gas system of an internal combustion engine, in particular of a diesel engine, in a passenger automobile. An internal combustion engine 26 which can be characterized by a stroke or piston displacement or capacity 25 is shown. The exhaust gas which is generated in the piston capacity 25 flows in the flow direction 48 through an exhaust gas line 43 to the surroundings. In order to convert the noxious substances contained in the exhaust gas, the exhaust gas is first fed to an oxidation catalytic converter 42, then to a particle filter 1 according to the invention with an overall volume 24 which is adapted to the piston capacity 25, and finally to a three-way catalytic converter 44. As a result it is, for example, also possible to carry out continuous regeneration of the particle filter 1.

The particle filter which is described herein constitutes an advantageous structure for overcoming the technical problems and requirements mentioned initially herein. By using a metallic fiber layer it is possible to manufacture the particle filter in a way which can easily be adapted to the purpose of use and in addition the given thermal conductivity of the metallic fiber layer and its specific thermal capacity which is made available permits permanent use in exhaust gas systems of automobiles even if very frequent regenerations are carried out during which so-called hot spots are occasionally formed.

We claim:

1. A particle filter, comprising:
a casing;
at least one body disposed in said casing, said at least one body having at least one metallic fiber layer;
said at least one metallic fiber layer having an area-related thermal capacity in a range of from 400-1200 Joule per Kelvin and square meter [J/Km²];
said at least one metallic fiber layer forming a multiplicity of spatially separate flow paths through said body; and
said flow paths each having a flow restrictor at least at one location.

2. The particle filter according to claim 1, wherein said at least one fiber layer has at least one of the following parameters in at least one section:
a) fiber diameter: 20 μm to 90 μm;
b) fiber spacing: 5 μm to 300 μm;
c) layer thickness: 0.2 mm to 1.5 mm;
d) layer weight per unit surface area: 250 g/m² to 2000 g/m²;
e) layer porosity: 30% to 90%;
f) fiber surface per 1 m² layer surface: 9 m² to 15 m²; and
g) length of individual fiber: 5 μm to 100 μm.

3. The particle filter according to claim 1, wherein said at least one fiber layer in said body has at least one of the following parameters:
a) specific layer surface: 0.15 m²/l to 2.0 m²/l; and
b) layer distance: 0.5 mm to 10 mm.

4. The particle filter according to claim 1, wherein said body has at least one supporting structure, and said at least one fiber layer has regions disposed at least partially adjacent one another being spaced apart from one another by said at least one supporting structure.

5. The particle filter according to claim 4, wherein said at least one supporting structure includes at least one of the following components, individually or multiply:
grid,
sheet metal,
wire, and
expanded metal.

6. The particle filter according to claim 1, wherein said body has components connected at least in certain regions to one another and/or to said casing by a joining technique.

7. The particle filter according to claim 4, wherein said at least one flow restrictor is part of said at least one supporting structure and closes off at least one of said flow paths at least at one location.

8. The particle filter according to claim 1, wherein said body has an inflow side and an outflow side, said at least one fiber layer has a course, and said at least one flow restrictor has a shape adapted at least partially to said course and closing off some of said flow paths at least near said inflow side or said outflow side of said body.

9. The particle filter according to claim 8, wherein said at least one flow restrictor includes a device for regenerating the particle filter and/or being suitable for determining at least one parameter selected from the group consisting of temperature and components of a gas flow.

10. The particle filter according to claim 1, wherein said body has an overall volume in a range of from 0.5 to 3.0 liters per 1.0 liter of piston capacity of a corresponding internal combustion engine.

11. The particle filter according to claim 1, wherein said body is a honeycomb body having a plurality of cells and a cell density per cross-sectional area through said body in a range of from 100 cpsi to 400 cpsi.

12. The particle filter according to claim 1, wherein said body has opposite inflow and outflow sides, said at least one metallic fiber layer is a multiplicity of fiber layers connected to one another alternately at said opposite inflow and outflow sides to form said flow restrictors and pockets, and supporting structures with a minimum height and a maximum height are provided between said fiber layers in an alternating orientation in adjacent pockets.

13. The particle filter according to claim 1, wherein said body has segments in axial direction with different or combined functions.

14. The particle filter according to claim 1, wherein said body has at least one internal boundary defined by said flow restrictors being aligned with one another.

15. The particle filter according to claim 1, which further comprises at least one collar surrounding said body and connecting said body to said casing.

16. The particle filter according to claim 1, which further comprises a coating at least partially provided on said body.

17. The particle filter according to claim 1, wherein said body has an inflow side and an outflow side, said flow restrictors are disposed near said inflow side or said outflow side, said at least one metallic fiber layer is a plurality of fiber layers, supporting structures are disposed between said fiber layers, and at least one of said fiber layers has a connecting section forming a technical joining connection to at least one flow restrictor and/or one supporting structure.

18. The particle filter according to claim 17, wherein said connecting section is a section of said at least one fiber layer having parameters different than other regions.

19. The particle filter according to claim 17, wherein said connecting section is a joined-on individual component.
